(19) United States
(12) Patent Application Publication
(10) Pub. No.: US 2025/0321642 A1
(43) Pub. Date: Oct. 16, 2025

(54) SINGLE-HANDED GESTURE-CONTROLLED OBJECT MANIPULATION IN VIRTUAL AND AUGMENTED REALITY

(71) Applicants: Deyvi Zamero, Stafford, VA (US); Berke Debensason, London (GB)

(72) Inventors: Deyvi Zamero, Stafford, VA (US); Berke Debensason, London (GB)

(21) Appl. No.: 18/631,307

(22) Filed: Apr. 10, 2024

(51) Int. Cl. G06F 3/01; G06F 3/0482; G06F 3/04845

(52) U.S. Cl. CPC G06F 3/017; G06F 3/011; G06F 3/016; G06F 3/0482; G06F 3/04845

(57) ABSTRACT

The present invention relates to a system for manipulating a virtual target object (VTO) in a virtual environment, and more particularly, to an intuitive and natural user interface for basic virtual object manipulations such as moving, rotating, and scaling through single-handed gestures, allowing for greater ease of use and accessibility and enabling users with physical disabilities to interact with virtual and augmented reality systems.

### BACKGROUND OF THE INVENTION

The present invention relates to a system for manipulating a virtual target object (VTO) in a virtual environment, and more particularly to user interfaces for use in connection with virtual and augmented reality systems, and to an intuitive and natural user interface for basic virtual object manipulations such as moving, rotating, and scaling through single-handed gestures, allowing for greater ease of use and accessibility and enabling users with physical disabilities to interact with virtual and augmented reality systems.

As hand detection technology of head-mounted displays (HMD) advances, physical control devices like joysticks will no longer be necessary, and hand gestures will be used to control actions. An essential feature of any gameplay that involves interaction between virtual objects and the user is the ability to manipulate and control objects that are located beyond the arm's reach of the user. Therefore, a hand gesture-based control mechanism is necessary for users to interact with distant objects. Existing methods for controlling virtual objects in virtual and augmented reality environments can be cumbersome, unnatural, and often require both hands, making it difficult for users with disabilities or those who prefer one hand.

As it stands, HMDs offer two types of control options: physical controllers and hand usage. When examining HMD products released by various brands on the market, it is possible to observe that they all have developed similar button and trigger structures for their physical control devices. This arrangement allows the same buttons and triggers to be used in similar applications across various devices for similar functions. Maintaining the controller-action relationship regardless of the device provides convenience and consistency for users.

Providing this fluid environment through controls is also important and necessary for hand control. In this context, some actions that could be applicable in all applications need to be associated with easy-to-remember and usable hand gestures.

Due to the nature of virtual and augmented reality environments, one of the primary sets of actions is the manipulation of distant virtual objects that are located beyond the arm's reach of the user. Moving, rotating, and scaling distant virtual objects quickly during gameplay is also one of the primary sets of actions for virtual and augmented reality environments. Hence many applications will require such interactions.

The manipulation systems in the current hand-controlled applications in the market do not provide adequate performance due to several factors; Fundamental actions, such as rotating objects, require using the rotation system with two hands. Using two hands creates a negative situation for users with one hand occupied or a physical disability. They cannot simultaneously move and rotate objects at a distance using a single hand. They also require both hands to increase and decrease an object's size.

Due to these reasons, a gesture-action system is needed to consist of memorable, easy-to-use, ergonomic hand gestures that every person can apply without difficulty. The hand recognition system can easily recognize that to provide a seamlessly working manipulation system.

This invention improves these systems by providing an intuitive and natural user interface for basic virtual object manipulations such as moving, rotating, and scaling through single-handed gestures, allowing for greater ease of use and accessibility and enabling users with physical disabilities to interact with the system.

### SUMMARY OF THE INVENTION

In one aspect of the present invention, in a preferred embodiment the present invention is directed to a software component defining a virtual and augmented reality interface that allows a user to manipulate near or far virtual objects using hand gestures they are accustomed to performing daily. In another aspect of the present invention, in a preferred embodiment the present invention offers a solution to the problem of requiring a more accessible and natural method for manipulating virtual objects in virtual and augmented reality environments using single-hand gestures. It enables the user to move, rotate, and scale the virtual objects accurately without needing physical control devices or using both hands.

These and other features, aspects and advantages of the present invention will become better understood with reference to the following drawings, description and claims.

### BRIEF DESCRIPTION OF THE DRAWINGS

FIG. 1 depicts various components of a virtual/augmented reality system comprising a general HDM, a user, a hand detection system, and an application in accordance with a preferred embodiment of the present invention;

FIG. 2 depicts activation of a menu module in accordance with a preferred embodiment of the present invention;

FIG. 3 depicts various grabbing and releasing principles of a virtual control object in accordance with a preferred embodiment of the present invention;

FIG. 4 depicts how the virtual control object can be used to control a virtual target object in accordance with a preferred embodiment of the present invention;

FIG. 5 depicts activation of a rotation module for rotations around an object's z-axis in accordance with a preferred embodiment of the present invention;

FIG. 6 depicts activation of the rotation module for rotations around the object's y-axis in accordance with a preferred embodiment of the present invention;

FIG. 7 depicts activation of the rotation module for rotations around the object's x-axis in accordance with a preferred embodiment of the present invention;

FIG. 8 depicts activation of a scale module for a decrease in scale in accordance with a preferred embodiment of the present invention; and

FIG. 9 depicts act activation of the scale module for an increase in scale in accordance with a preferred embodiment of the present invention

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

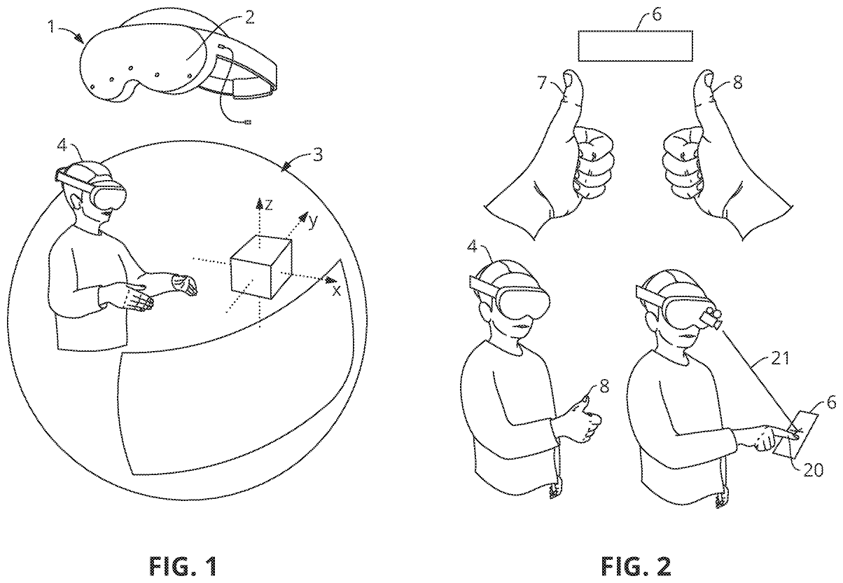

Broadly speaking, as described herein and as shown in FIGS. 1-9, an embodiment of the present invention comprises eight primary components:

C1—HMD 1: The VR/AR headset 1, also known as a Head-Mounted Display (HMD), is a type of device that typically consists of a set of goggles or a helmet that is worn on the head of a user and contains a display screen(s) to present virtual or augmented reality environments to the user 4. HMDs often have built-in sensors to track head movements, allowing users 4 to look around and interact with the virtual or augmented environment more naturally. (See FIG. 1, by way of example).

C2—Hand detection technology 2: Hand detection technology 2 for HMD 1 comprises a type of computer vision technology that uses cameras and algorithms to recognize and track the movements of a user's hands in the virtual or augmented reality environment. It allows users 4 to interact with virtual objects and perform actions using natural hand gestures without needing physical controllers. The technology typically involves deep learning algorithms that recognize and interpret various hand movements, such as grabbing, pointing, swiping, rotating, and translate them into actions in the VR or AR environment. (See FIG. 1, by way of example).

C3—App 3: This software application 3 is designed to run on a virtual or augmented reality headset 1. These apps are designed to offer users 4 immersive and interactive experiences through the headset's audio, visual, and tracking capabilities. Examples of apps 3 that can run on an HMD 1 include games, simulations, educational tools, and productivity software, to name a few. These apps 3 often leverage the unique features of the HMD 1, such as hand tracking or motion sensing, to provide an experience that feels natural and engaging. (See FIG. 1, by way of example).

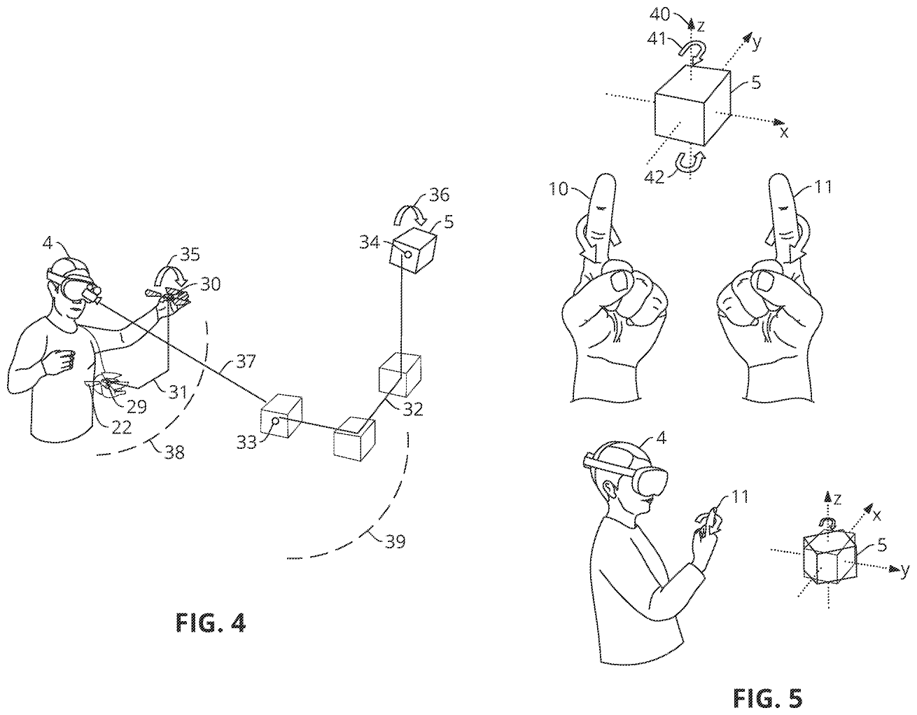

C4—Virtual Target Object (VTO) 5: In an AR/VR app, a virtual object is a 3D digital representation of an object generated by computer graphics and superimposed onto the real world in AR or presented in a fully immersive virtual environment in VR. These objects can range from simple geometric shapes to complex, lifelike representations of real-world or imaginary objects. They can be pre-existing in the game 3 or imported at runtime and are designed to respond to user interactions such as hand gestures or controller input. The object that is the focus of manipulation will be referred to in this document as the Virtual Target Object (VTO) 5. Also, a user 4 can select a VTO 5 from among multiple virtual objects in a scene based on their needs in the gameplay. (See FIG. 4, by way of example).

C5—The Menu Module 6: The Menu Module 6 is a software component that defines a user interface element to house important menu buttons in a gameplay environment. These buttons interact with touch input from the user's finger 20 or via a virtual ray. The Menu Module 6 open/close action is triggered by hand gesture Gesture 1.1 7 or Gesture 1.2 8, allowing seamless and intuitive navigation within the game. (See FIG. 2, by way of example).

C6—The Move Module: The Move Module is a software component that allows the user 4 to change the location and rotation of VTO 5 near or out of their arm's reach. This module generates the Virtual Control Object (VCO) 22, a virtual joystick for the VTO 5, which operates on the principle that the VTO 5 mimics the location and rotation changes of the VCO 22 via an algorithm. (See FIG. 4, by way of example).

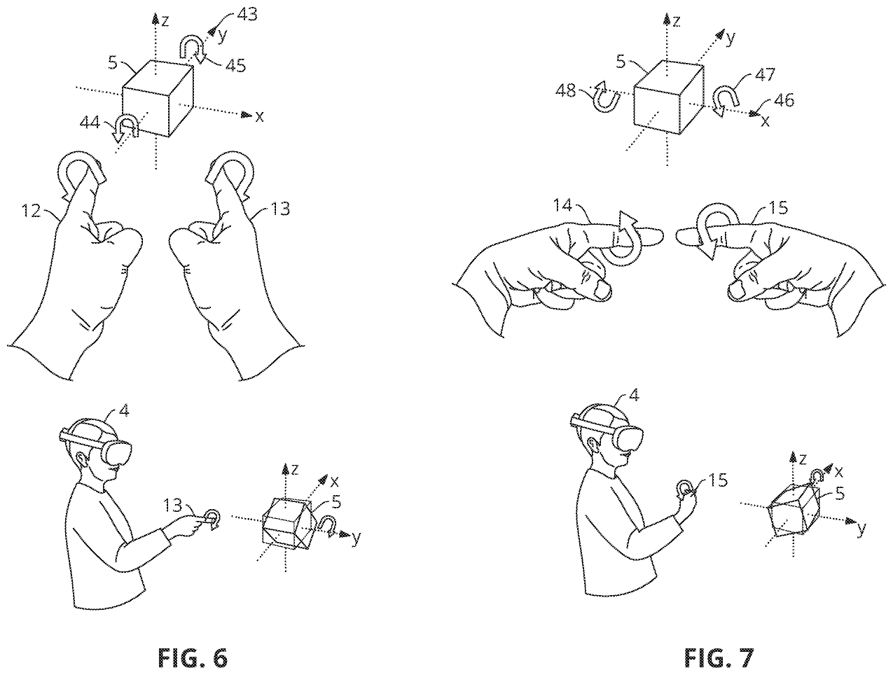

C7—The Rotation Module: The Rotation Module is a software component allowing users to rotate objects near or out of their arm's reach. Rotating refers to the ability to rotate the VTO 5 around its three main axes (x,y,z). The following gestures are used for rotating the VTO 5 around its three main axes (See FIG. 5, FIG. 6, and FIG. 7 by way of example):
2.1p1 10, 2.2p1 11 rotate on Z;
2.1p2 12, 2.2p2 13 rotate on Y; and
2.1p3 14, 2.2p3 15 rotate on X.

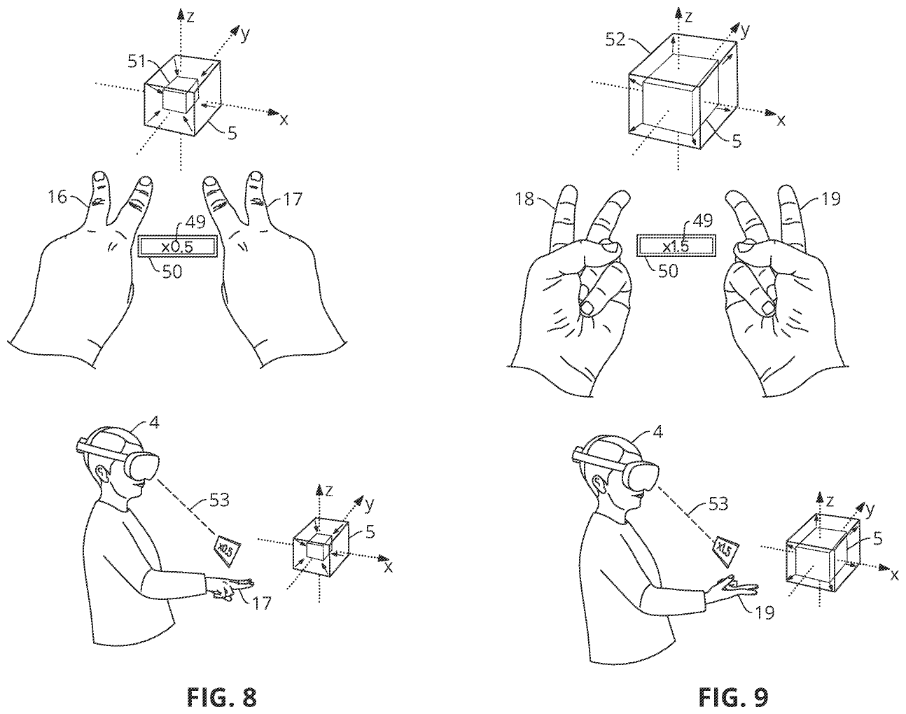

C8—The Scale Module: The Scale Module is a software component that allows user 4 to adjust the size of objects, either larger or smaller. This adjustment, also known as scaling, involves changing the original size of the VTO 5 in all dimensions. The module is activated via the following hand gestures (See FIG. 8 and FIG. 9 by way of example):
3.1p1 16, 3.2p1 17 scale down; and
3.1.p2 18, 3.2p2 19 scale up.

The eight primary components described above create an immersive virtual and augmented reality experience. Once the AR/VR app 3 is launched, user 4 can select the Virtual Target Object (VTO) 5 to manipulate. This VTO 5 can be assigned by the system by default or chosen by the user 4. The user's hand gestures will control the VTO 5. The VTO 5 can be moved in space (x,y,z axis), rotated (x,y,z axis), or proportionally scaled using single-hand gestures. All gestures perform an algorithm similar to a joystick; no matter the distance between the user 4 and the VTO 5, the user 4 can manipulate it via hand gestures. This enables the user 4 to position the VTO 5 to distant locations without changing his/her location in physical space.

After selecting the Virtual Target Object (VTO) 5, the system continuously monitors the user's hand gestures. The application menu 6 allows the user 4 to easily access essential functions, such as navigation, settings, and user profile.

When the user 4 performs Gesture 1.1 7 or Gesture 1.2 8, the system checks whether the Menu Module is active. If the Menu Module is inactive, the system activates the Menu Module and displays the menu panel 6. While the Menu Module is active, menu panel 6 will be hidden if the gesture is performed again. The menu panel 6 will always be shown at a location relative to the user's camera position 21 and will remain in that position until Gesture 1.1 7 or Gesture 1.2 8 is performed again. (See FIG. 2, by way of example).

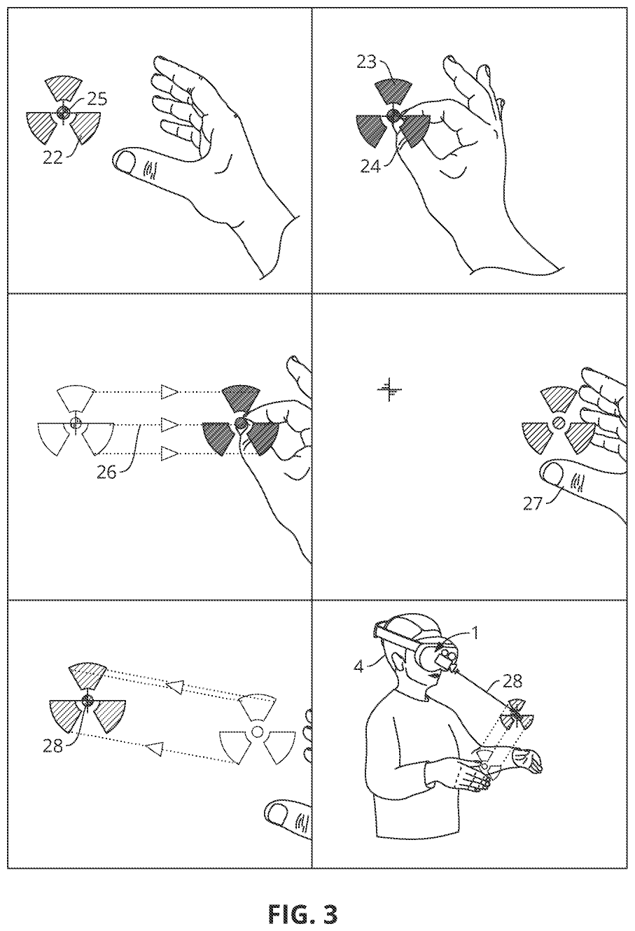

Move Module creates the Virtual Control Object (VCO) 22. The VCO 22 can be shaped in any form, such as a star, cube, or sphere, and textured with any material. Initially, the VCO 22 appears at a location relative to the user's camera position 25 when the move module is initiated by either pressing a button or performing a hand gesture. This location is determined by analyzing the user's headset 1 height from the floor position and the optimum arm's reach distance. The VCO has two states; active 23 and inactive 22. The VCO 22 initially starts as an inactive state, and when the user 4 touches or holds the VCO 22, the state of the VCO 22 changes to active 23. During the state changes, there is visual and auditory feedback. The user 4 can hold and move the VCO 22 using either their left or right hand from any point of its geometry 24. When the VCO 22 is moved 26 and then released 27, the VCO 22 will automatically move to a location relative to the user's camera position 28. (See FIG. 3, by way of example).

When the VCO 22 is moved from point A 29 to point B 30, the position difference between the VCO's x, y, and z-axis 31 is appended to the existing position of the Virtual Target Object (VTO) 5 and moved from point C 33 to point D 34. For example, if the existing VTO 5 coordinates are Vector (x1, y1, z1) and VCO 22 is moved 0.1 meters forward, left, and up 31, the VTO 5 coordinates shall be updated to Vector (x1+0.1, y1+0.1, z1+0.1) 32 given the Speed Multiplier is one unit. When the VCO 22 is rotated 35 in any direction (X, Y, Z), the Virtual Target Object (VTO) 5 will mimic the same rotation 36. If the existing VTO 5 Euler angles are Vector (0, 0, 0) and VCO 22 is rotated 90 degrees on the Y axis, the VTO 5 Euler angles shall be updated to Vector (0, 90, 0). (See FIG. 4, by way of example).

In order to reduce the number of hand movements while moving an object far away, the Move Module comes up with the Speed Multiplier. While moving the VCO 22, the system applies Speed Multiplier to accelerate or decelerate the speed of the movement of the VTO 5 within limits. The Speed Multiplier is determined by the distance between the user 4 and the VTO 5 at the moment of action 37. Minimum and maximum thresholds are defined by virtual spheres around the user's camera, and it is configurable in the system. The farther the VTO 5 is moved away from the user 4, the faster the movement will be. The Speed Multiplier is set to one if the distance between VTO 5 and the user 4 is under the minimum threshold 38. This will allow the VTO 5 to mimic the exact movement of the VCO 22 when the objects are very near. The Speed Multiplier increases linearly the farther the VTO 5 moves away from the user 4 until the maximum threshold 39 is reached. Once the maximum threshold limit is exceeded, the speed will remain constant at its maximum level. (See FIG. 4, by way of example).

This approach reduces arm fatigue due to excessive hand movements. When the VCO 22 is released 27, the system stops moving or rotating the VTO 5, and the VCO 22 will automatically move to a location relative to the user's camera position 28. (See FIG. 3, by way of example).

When the user 4 performs Gestures 2.1p1 10, and 2.2p1 11, the Rotation Module waits for a predetermined amount of time before starting a continuous rotation of the Virtual Target Object (VTO) 5 around the z-axis 40. The grace period is needed to ensure the gesture was not performed accidentally.

Gesture 2.1p1 10 rotates VTO 5 around its z-axis counterclockwise 42, whereas Gesture 2.2p1 11 rotates VTO 5 around the z-axis clockwise 41. If the user 4 stops performing the gesture, the system stops rotating the VTO 5. (See FIG. 5, by way of example).

When the user 4 performs Gestures 2.1p2 12, and 2.2p2 13, the Rotation Module waits for a predetermined amount of time before starting a continuous rotation of the Virtual Target Object (VTO) 5 around the y-axis 43. The grace period is needed to ensure the gesture was not performed accidentally. Gesture 2.1p2 12 rotates the VTO 5 around its y-axis counterclockwise 44, whereas Gesture 2.2p2 13 rotates VTO 5 around the y-axis clockwise 45. If the user 4 stops performing the gesture, the system stops rotating the VTO 5. (See FIG. 6, by way of example).

When the user 4 performs Gestures 2.1p3 14, and 2.2p3 15, the Rotation Module waits for a predetermined amount of time before starting a continuous rotation of the Virtual Target Object (VTO) 5 around the x-axis 46. The grace period is needed to ensure the gesture was not performed accidentally. Gesture 2.1p3 14 rotates the VTO 5 around its x-axis counterclockwise 48, whereas Gesture 2.2p3 15 rotates VTO 5 around the x-axis clockwise 47. If the user 4 stops performing the gesture, the system stops rotating the VTO 5. (See FIG. 7, by way of example).

When the system detects Gestures 3.1p1 16, 3.2p1 17, 3.1.p2 18, and 3.2p2 19 are performed, it activates The Scale Module. If one of the scale gestures is performed for less than 1 second, the system displays the scale menu 50, which shows the scale factor 49 of the Virtual Target Object (VTO) 5 and disappears. (See FIG. 8 and FIG. 9, by way of example).

If Gesture 3.1p1 16 or 3.2p1 17 is performed longer than 1 second, the system displays the scale menu showing the scale factor and simultaneously starts to change the scale factor of the VTO 5 in every axis. As a result, the VTO 5 decreases in size proportionally 51. (See FIG. 8, by way of example).

If Gesture 3.1p1 18 or 3.2p1 19 is performed longer than 1 second, the system displays the scale menu 50 showing the scale factor 49 and simultaneously starts to change the scale factor of the VTO 5 in every axis. As a result, the VTO 5 increases in size proportionally 52. (See FIG. 9, by way of example) There are configurable lowest and highest scale factor boundaries that can be set to limit the scale factor; otherwise, the scale factor can be set to unlimited. The scale menu 50 will always be shown at a location relative to the user's camera position 53 and will remain in that position until the scale gesture is released. (See FIG. 8 and FIG. 9, by way of example).

The following examples are exemplary only and included to further describe preferred embodiments of the present invention. Broadly speaking, the present invention is directed to a system that utilizes hand gestures to perform various actions such as activating a menu, moving, rotating, and scaling virtual objects in a virtual environment. The system uses a combination of computer vision and machine learning to recognize the user's hand gestures and execute the corresponding actions.

In a preferred embodiment the present invention outlines the specific gestures and actions, as well as the configurable parameters that can be set to limit certain actions. Overall, the present invention is directed towards an innovative way to interact with virtual objects in a natural and intuitive way, without the need for physical controllers, other input devices, or the use of both hands.

In a preferred embodiment, the system of the present invention comprises a Menu Module that can be activated by performing Gesture 1.1 or Gesture 1.2 when the Menu Module is inactive and that displays a menu at a location relative to the user's camera position, which remains in that position until Gesture 1.1 or Gesture 1.2 is performed again. The menu will be hidden if the gesture to activate the Menu Module is performed again while the Menu Module is active. The location of the menu is relative to the user's camera position and is determined by the system. The menu can be customized and modified to display different items, options, or functionalities based on the user's preferences and the system's capabilities.

The user can interact with the menu by performing various gestures, such as tapping or swiping, to select or activate different items or options. The Menu Module can be combined with other modules, such as the Rotate Module or the Scale Module, to provide a comprehensive user experience for manipulating the Virtual Target Object (VTO). The menu can be configured to display different types of content, such as text, images, or multimedia, based on the user's preferences and the system's capabilities. The system can provide visual feedback to the user during menu interaction, such as highlighting or animating selected items or options. The system can also provide haptic feedback to the user during menu interaction, such as vibrating the device or providing resistance to the user's gesture. The Menu Module can be activated by other means besides Gesture 1.1 or Gesture 1.2, such as voice commands or physical buttons, based on the system's capabilities and the user's preferences.

As described herein, and as seen in FIGS. 1-9, in a preferred embodiment the present invention also comprises a Move Module that creates a Virtual Control Object (VCO) which can be shaped in any form and textured with any material, said VCO initially appears at a location relative to the user's camera position when the Move Module is initiated by pressing a button or performing a hand gesture, said location is determined by analyzing the user's headset height from the floor position and the optimum arm's reach distance. The VCO has two states, inactive and active, and can be held and moved using the user's left or right hand from any point of its geometry. When the VCO is moved and released, it automatically moves to a location relative to the user's camera position. The position difference between the VCO's x, y, and z-axis is appended to the existing position of the Virtual Target Object (VTO) and moved accordingly. When the VCO is rotated in any direction, the Virtual Target Object (VTO) mimics the same rotation. The system applies a Speed Multiplier to accelerate or decelerate the speed of the movement of the VTO based on the distance between the user and the VTO at the moment of action. The Speed Multiplier increases linearly the farther the VTO moves away from the user until the maximum threshold is reached. Once the VCO is released, the VCO stops moving or rotating, and the VCO will automatically move to a location relative to the user's camera position.

As described herein, and as seen in FIGS. 1-9, in a preferred embodiment the present invention also comprises a system in which a Rotate Module can be activated by performing Gesture 2.1 or Gesture 2.2 when the Rotate Module is inactive and that rotates the Virtual Target Object (VTO) around its predetermined pivot point by a specified degree based on the user's gesture. The rotation will stop when the user releases the gesture or when the maximum degree of rotation is reached, which can be configured based on the system's capabilities and the user's preferences. The rotation can be performed around a specific axis, such as the X, Y, or Z axis, based on the user's gesture and the system's configuration. The Rotate Module can be combined with other modules, such as the Menu Module or the Scale Module, to provide a comprehensive user experience for manipulating the VTO. The system can provide visual feedback to the user during the rotation process, such as showing the current degree of rotation or displaying a preview of the final result. The system can also provide haptic feedback to the user during the rotation process, such as vibrating the device or providing resistance to the user's gesture. The system can include a calibration process to ensure accurate and precise rotation based on the user's gesture and the system's configuration.

As described herein, and as seen in FIGS. 1-9, in a preferred embodiment the present invention also comprises a system having a Scale Module that can be activated by performing Gesture 3.1p1, Gesture 3.2p1, Gesture 3.1p2, or Gesture 3.2p2, and that displays a scale menu showing the scale factor of the Virtual Target Object (VTO) at a location relative to the user's camera position. If one of the scale gestures is performed for less than 1 second, the scale menu will appear briefly and disappear. If Gesture 3.1p1 or Gesture 3.2p1 is performed longer than 1 second, the system displays the scale menu showing the scale factor and simultaneously starts to decrease the size of the VTO in every axis proportionally. If Gesture 3.1p2 or Gesture 3.2p2 is performed longer than 1 second, the system displays the scale menu showing the scale factor and simultaneously starts to increase the size of the VTO in every axis proportionally. The scale factor can be limited by configurable lowest and highest scale factor boundaries or set to unlimited. The scale menu will remain in the same location relative to the user's camera position until the scale gesture is released.

In a preferred embodiment, combining these modules enables the user to quickly and intuitively interact with virtual objects and perform complex actions such as manipulating and scaling objects without needing additional physical controllers or input devices. These modules can be extended with additional features to improve their functionalities.

For example, the VCO can be generated at the exact point where the user performs Gesture X (any hand gesture). When the user releases Gesture X, the VCO will not return to a predetermined position but instead will be hidden. If the user performs Gesture X again, the process will be repeated. This makes the VCO invisible, giving the user the impression that they control the VTO solely through hand gestures. Such logic can enhance the user's experience by creating a more seamless and immersive interaction with the virtual environment.

For example, an AR/VR application where the user is manipulating a virtual object, such as a 3D model of a car. By using the hand gesture controls provided by the hand detection technology, the user can move, rotate, and scale the car model as desired. However, the default scaling speed may need to be faster for the user's liking. The software can be programmed to adjust the scaling speed based on the angle between the user's fingers and fist. For instance, if the user has a wide angle between their fingers and fist, indicating that they want to scale the object quickly, the software can increase the scaling speed. Conversely, the software can slow the scaling speed if the narrow-angle indicates a desire for finer control. This feature allows more customizable and sensitive control over the virtual object, improving the overall user experience.

For example, in a virtual reality game where the user controls a spaceship and must navigate through a series of obstacles, collisions can occur. The system can collaborate with physics to make the experience more realistic by implementing collision detection and response. When a collision occurs, the system can ignore changes to the VCO and adjust the position and velocity of the spaceship based on the laws of physics, such as the conservation of momentum and energy. This can improve the immersion and realism of the game, making it feel more like the user is piloting a spaceship through space.

A sensitivity factor could also be added to the Move Module, neglecting minimal hand movements. This would prevent accidental movements of the virtual object and improve the accuracy of user input. A user uses an AR application to place virtual furniture in a physical room. The user wants to move a virtual chair to a specific location, but the hands are naturally not still. Without a sensitivity factor, even the slightest hand movements would cause the chair to move, making it difficult to place it precisely in the desired location. With a sensitivity factor added to the Move Module, the application would only recognize hand movements that exceed a certain threshold, say 5 millimeters. This means that small, natural hand movements would be ignored, and the virtual object would only move when the user intentionally moves their hands beyond the sensitivity threshold. This would make it much easier to place the virtual chair in the exact position without it constantly shifting due to natural hand tremors.

There could also be more than one virtual object in the scene, and the user has to decide with which of them he/she will interact. In these cases, a multiple selection module could enable the user to select multiple objects together and perform actions on all of them. The system generates a virtual invisible rectangular boundary (Virtual Control Boundary, VCB) around selected objects. It performs actions based on the geometry of VCB, which as a result, moves objects from the center point of VCB, rotates around the central axis of VCB, and scales accordingly.

The above modules can also be triggered with specified buttons on the controller instead or in addition to hand gestures. This can be especially useful for those who may have difficulty with hand gestures or prefer the familiarity of physical controllers. Modules that are subject to patent can also be used with hand controllers, where the triggers, such as hand gestures, will be replaced by the signals received from the controller.

It should be understood, of course, that the foregoing relates to exemplary embodiments of the invention and that modifications may be made without departing from the spirit and scope of the invention as set forth in the following claims.

What is claimed is:

1. A system for manipulating a virtual target object (VTO) in a virtual environment, said system comprising a menu module that can be activated by a user performing a first gesture or second gesture when the menu module is inactive, said system displaying said menu in response to said first or second gesture, and wherein the menu will be hidden if the first gesture or the second gesture is performed again while the menu module is active, and wherein once active a user can interact with the menu by tapping or swiping to select or activate options from the menu, wherein the system provides visual or haptic feedback to the user during menu interaction.

2. The system of claim 1 wherein the first gesture comprises a thumbs up gesture of the user's left hand, and the second gesture comprises a thumbs up gesture of the user's right hand.

3. A system for manipulating a virtual target object (VTO) in a virtual environment comprising a move module that creates a virtual control object (VCO) having an x, y and z axis and which can be shaped in any form and textured with any material, wherein said VCO initially appears at a location relative to a user's camera position when the move module is initiated by pressing a button or performing a hand gesture, and wherein said location is determined by analyzing a user's headset height from a floor position and an optimum arm's reach distance.

4. The system of claim 3 wherein a position difference between the VCO's x, y, and z-axis is appended to the existing position of the VTO and moved accordingly.

5. The system of claim 3 wherein when the VCO is rotated in any direction, the VTO mimics the same rotation, and wherein the system applies a speed multiplier to accelerate or decelerate the speed of the movement of the VTO based on the distance between the user and the VTO at the moment of action.

6. The system of claim 3 wherein the speed multiplier increases linearly the farther the VTO moves away from the user until a maximum predetermined threshold is reached.

7. A system for manipulating a virtual target object (VTO) in a virtual environment comprising a rotate module that can be activated by performing a first gesture or a second gesture when the rotate module is inactive and that rotates the VTO around a predetermined pivot point by a specified degree based on a user's first or second gesture, and wherein the rotation will stop when a user releases the first or the second gesture or when a maximum degree of rotation is reached, wherein the rotation is performed around an X, Y, or Z axis based on the first or second gesture.

8. The system of claim 7 wherein the first gesture comprises the user's left index finger positioned and rotating vertically, and the second gesture comprises the user's right index finger positioned and rotating vertically.

9. The system of claim 7 further comprising a scale module that can be activated by performing a first scale gesture, a second scale gesture, a third scale gesture or a fourth scale gesture, and that displays a scale menu showing the scale factor of the VTO at a location relative to a user's camera position.

10. The system of claim 9 wherein if one of the scale gestures is performed for less than 1 second, the scale menu will appear briefly and disappear.

11. The system of claim 9 wherein if the first scale gesture or the second scale gesture is performed longer than 1 second, the system displays the scale menu showing the scale factor and simultaneously starts to decrease the size of the VTO in every axis proportionally.

12. The system of claim 9 wherein if the third scale gesture or the fourth scale gesture is performed longer than 1 second, the system displays the scale menu showing the scale factor and simultaneously starts to increase the size of the VTO in every axis proportionally.

13. The system of claim 9 wherein the first, second, third or furth scale gestures comprises the user's left index and middle fingers positioned and rotating horizontally.
